(19) United States
(12) Patent Application Publication
(10) Pub. No.: US 2026/0348501 A1
(43) Pub. Date: Nov. 5, 2026

(54) FLUID TRANSFERRING CONNECTOR

(71) Applicant: Surpass Industry Co., Ltd., Saitama (JP)

(72) Inventors: Masahiro HASUNUMA, Saitama (JP); Masamichi KOBAYASHI, Saitama (JP)

(21) Appl. No.: 19/648,485

(22) Filed: Apr. 15, 2026

(30) Foreign Application Priority Data
Apr. 30, 2025 (JP) 2025-075480

(51) Int. Cl. F16L 37/23; F16L 37/32

(52) U.S. Cl. CPC F16L 37/23; F16L 37/32

(57) ABSTRACT

Provided is a fluid transferring connector in which the socket has a ball lock mechanism configured to fix a first accommodation part to the housing part, the ball lock mechanism has a sleeve having restriction parts that restricts lock balls into a state of being engaged with the engagement groove, a spring configured to push the sleeve toward a position where the restriction parts come into contact with the lock balls, and a stop ring against which the sleeve is abutted, the sleeve has a first slope face whose inner diameter gradually expands at a gradient of a predetermined angle toward one end side, the stop ring has a second slope face whose outer diameter gradually expands at a gradient of the predetermined angle toward one end side, and the first slope face is abutted against the second slope face by a biasing force generated by the spring.

### CROSS-REFERENCE TO RELATED APPLICATIONS

This application claims foreign priority benefits under U.S.C. §119 to Japanese Patent Application No. 2025-075480 filed on Apr. 30, 2025, the contents of which is hereby incorporated by reference in its entirety.

### BACKGROUND

### Technical Field

The present disclosure relates to a fluid transferring connector.

### Description of Related Art

As illustrated in Japanese Patent Application Laid-Open No. 2020-128753 (hereafter, referred to as PTL 1), for example, fluid transferring connectors are used to transfer fluids (chemical liquids or gases) used in semiconductor manufacturing devices.

The fluid transferring connector includes, for example, a socket stationarily installed on a building side provided with a buffer tank that temporarily stores a fluid and a plug fixed to an end of a hose guided from a tank truck. The plug is connected to the socket, and thereby a fluid is transferred from the tank truck to the buffer tank.

In a fluid transferring connector disclosed in PTL 1, the plug is inserted in and secured in a receptacle on the socket side, and the tip of the plug and the tip of the socket are then cleaned. Then, an internal mechanism of the socket is moved forward on the plug side, thereby a valve part on the plug side and a valve part on the socket side are abutted against each other and, at the same time, respective valve parts are receded from each other to form a channel, and a fluid is transferred.

In the fluid transferring connector disclosed in PTL1, it is conceivable to employ, for example, a ball lock mechanism disclosed in Japanese Patent Application Laid-Open No. 2017-226454 (hereafter, referred to as PTL2) in order for the operator to easily connect and disconnect the socket and the plug to and from each other. The ball lock mechanism is to engage a plurality of lock balls with an engagement groove and then secure the lock balls in the engagement groove to maintain a state where the plug and the socket are connected to each other.

For example, by adopting the ball lock mechanism of PTL2 to the socket of the fluid transferring connector disclosed in PTL1, the operator may easily perform operation to connect the plug to the socket. In the ball lock mechanism disclosed in PTL2, a biasing force generated by a spring is transferred to a sleeve, the sleeve is abutted against a stop ring, thereby restriction parts of the sleeve come into contact with the lock balls, and a state where the lock balls are secured in the engagement groove is obtained.

In the ball lock mechanism disclosed in PTL2, however, when the sleeve is abutted against the stop ring in a state where the central axis of the sleeve does not match the central axis of the plug and the socket, this results in a state where some of the restriction parts of the sleeve are not in contact with the lock balls, and the state where the lock balls are reliably secured in the engagement groove may not be obtained. In such a case, the state where the plug and the socket are connected to each other is not suitably maintained, and, for example, when a load is applied to the plug, the plug may be unexpectedly disconnected from the socket.

The present disclosure has been made in view of such circumstances and intends to provide a fluid transferring connector that can obtain a state where lock balls are reliably secured in an engagement groove when a plug is secured in a socket by a ball lock mechanism.

### SUMMARY

The present disclosure employs the following solutions to achieve the above object.

The fluid transferring connector according to the first aspect of the present disclosure includes: a plug configured to be attached to an end of a first pipe, a fluid being allowed to flow through the first pipe; and a socket configured to be connected to a second pipe, the plug being inserted in the socket, a fluid flowing in from the first pipe being allowed to flow out of the second pipe. The plug includes a first valve part, a cylindrical first accommodation part that accommodates the first valve part movably along a first axis, and a first biasing force generation part configured to generate a biasing force so as to cause the first valve part to come into contact with the first accommodation part into a first closed state where the fluid in the first pipe does not flow out of the first accommodation part. The socket includes a second valve part, a cylindrical second accommodation part that accommodates the second valve part movably along a second axis, a second biasing force generation part configured to generate a biasing force so as to cause the second valve part to come into contact with the second accommodation part into a second closed state where no fluid flows into the second accommodation part, a cylindrical housing part having one end and the other end along the second axis, the first accommodation part being inserted in the one end side, and the second accommodation part being inserted in the other end side, and a ball lock mechanism configured to fix the first accommodation part not to move along the second axis with respect to the housing part. The ball lock mechanism includes a plurality of lock balls accommodated in a plurality of open holes formed at a plurality of portions in a circumferential direction about the second axis of a tip part of the housing part, a sleeve formed in a circular cylindrical shape about the second axis and arranged on an outer circumferential side of the tip part, and the sleeve having restriction parts configured to restrict the lock balls accommodated in the open holes into a state where the lock balls are engaged with an engagement groove formed about the first axis in an outer circumferential face of the second accommodation part, a third biasing force generation part fixed to the second accommodation part and configured to push the sleeve toward a position where the restriction parts come into contact with the lock balls, and an abutment part attached to the tip part of the housing part and formed annularly about the second axis, the sleeve pushed by the third biasing force generation part being abutted against the abutment part. The sleeve has a first slope face arranged facing the abutment part along the second axis and having an inner diameter that gradually expands at a gradient of a predetermined angle toward one end side along the second axis, the abutment part has a second slope face arranged facing the first slope face along the second axis and having an outer diameter that gradually expands at a gradient of the predetermined angle toward one end side along the second axis, and the first slope face is abutted against the second slope face by a biasing force generated by the third biasing force generation part.

According to the fluid transferring connector of the first aspect of the present disclosure, the operator inserts the plug into the socket and operates a ball lock mechanism of the socket, and thereby the plug is fixed so as not to move along the second axis with respect to the housing part of the socket. Once the second accommodation part is moved along the second axis to switch the blocked state to the flow-through state with the plug being fixed to the housing part, the first valve part of the plug and the second valve part of the socket come into contact with each other. This results in a state where a fluid flows from the first pipe on the plug side to the second pipe on the socket side.

According to the fluid transferring connector of the first aspect of the present disclosure, when the plug is inserted in the socket, once the sleeve pushed by the third biasing force generation part is abutted against the abutment part with the lock balls being engaged with the engagement groove, the restriction parts of the sleeve come into contact with the lock balls, and the lock balls are restricted into a state of being engaged with the engagement groove. When the sleeve is abutted against the abutment part, the first slope face of the sleeve and the second slope face of the abutment part come into contact with each other.

When the central axis of the sleeve does not match the central axis of the abutment part, the first slope face is moved while being in contact with the second slope face by the biasing force transferred from the third biasing force generation part to the sleeve so that the central axis of the sleeve matches the central axis of the abutment part. Accordingly, even when the first slope face comes into contact with the second slope face in a state where the central axis of the sleeve does not match the central axis of the abutment part, the sleeve is moved so that the central axis of the sleeve matches the central axis of the abutment part. In such a way, according to the fluid transferring connector of the first aspect of the present disclosure, since a state where the central axis of the sleeve matches the central axis of the abutment part is obtained, a state where the lock balls are reliably secured in the engagement groove can be obtained when the plug is secured in the socket by the ball lock mechanism.

The fluid transferring connector according to the second aspect of the present disclosure is further configured as follows in the first aspect. That is, the ball lock mechanism has a transfer part configured to support one end side on the second axis of the third biasing force generation part and transfer a biasing force generated by the third biasing force generation part to the sleeve, the housing part has grooves formed at positions where the open holes in the outer circumferential face of the tip part are arranged and extending from the open holes toward the other end side along the second axis, the transfer part has protruding parts formed at a plurality of portions in the circumferential direction and accommodated in the grooves when the third biasing force generation part contracts along the second axis, and the protruding parts more protrude to the lock balls side than the restriction parts.

According to the fluid transferring connector of the second aspect of the present disclosure, once the operator inserts the plug into the socket, the outer circumferential face of the plug comes into contact with the lock balls, and the lock balls are moved toward the other end side along the second axis. When the lock balls are moved, the lock balls come into contact with the protruding parts that more protrude to the lock balls side than the restriction parts, and the lock balls are moved along the second axis to the position where the lock balls are restricted by the open holes. Once the operator applies a force to further insert the plug into the socket, the lock balls are moved outward radially from the open holes, and a state where the lock balls are engaged with the engagement groove formed in the outer circumferential face of the first accommodation part of the plug is then obtained.

Once a state where the lock balls are engaged with the engagement groove is obtained, a biasing force generated by the third biasing force generation part is transferred to the sleeve via the transfer part into a state where the sleeve is abutted against the abutment part. In this state, the restriction parts of the sleeve come into contact with the lock balls, and the lock balls are restricted into a state of being engaged with the engagement groove. In such a way, by performing operation to hold and insert the plug into the socket without touching the sleeve, the operator is able to obtain a state where the plug is secured in the socket.

According to the fluid transferring connector of the second aspect of the present disclosure, the grooves that accommodate the protruding parts when the protruding parts are moved along the second axis are formed only at positions of the housing part where the open holes are arranged. Thus, while the thickness of the tip part of the housing part in the region in which each groove is formed is smaller by the size of the groove, the thickness of the tip part is larger in the region in which the groove is not formed than in the region in which the groove is formed. With such a sizing, the strength of the housing part is sufficiently ensured, and a state where the plug is secured in the socket by the ball lock mechanism can be reliably maintained even when a load due to the weight of the first pipe and a fluid flowing through the first pipe acts on the plug.

The fluid transferring connector according to the third aspect of the present disclosure is further configured as follows in the first aspect or the second aspect. That is, the first slope face and the second slope face are formed continuously in the circumferential direction.

According to the fluid transferring connector of the third aspect of the present disclosure, even when the central axis of the sleeve is shifted at any position in the circumferential direction with respect to the central axis of the abutment part, the first slope face can be moved while being in contact with the second slope face so that the central axis of the sleeve matches the central axis of the abutment part.

The fluid transferring connector according to the fourth aspect of the present disclosure is further configured as follows in the first aspect or the second aspect. That is, the socket has a moving mechanism configured to move the second accommodation part in a direction toward or away from the first accommodation part along the second axis with respect to the housing part to perform switching between a flow-through state where the first valve part and the second valve part are in contact with each other and a blocked state where the first valve part and the second valve part are not in contact with each other.

According to the fluid transferring connector of the fourth aspect of the present disclosure, by moving the second accommodation part along the second axis by using the moving mechanism with the plug being fixed to the housing part by the ball lock mechanism, it is possible to switch the blocked state to the flow-through state while allowing the first valve part of the plug and the second valve part of the socket to be in contact with each other. Further, by moving the second accommodation part along the second axis by using the moving mechanism, it is possible to switch the flow-through state to the blocked state while allowing the first valve part of the plug and the second valve part of the socket to be spaced apart from each other.

According to the present disclosure, it is possible to provide a fluid transferring connector that can obtain a state where the lock balls are reliably secured in the engagement groove when the plug is secured in the socket by the ball lock mechanism.

### BRIEF DESCRIPTION OF THE DRAWINGS

FIG. 1 is a longitudinal sectional view illustrating a fluid transferring connector according to one embodiment of the present disclosure, which illustrates an uncoupled state where a plug is disconnected from a socket.

FIG. 2 is a longitudinal sectional view illustrating the fluid transferring connector according to one embodiment of the present disclosure, which illustrates a coupled state where the plug is coupled to the socket and a blocked state where a first pipe and a second pipe are not in communication with each other.

FIG. 3 is a longitudinal sectional view illustrating the fluid transferring connector according to one embodiment of the present disclosure, which illustrates a coupled state where the plug is coupled to the socket and a flow-through state where the first pipe and the second pipe are in communication with each other.

FIG. 4 is a partial enlarged view of the plug illustrated in FIG. 2.

FIG. 5 is a partial enlarged view of the socket illustrated in FIG. 2.

FIG. 6 is a diagram of the socket illustrated in FIG. 1 when viewed from the tip side of the second valve part along an axis.

FIG. 7 is a longitudinal sectional view illustrating the ball lock mechanism, which illustrates a state where the plug is pushed against lock balls.

FIG. 8 is a longitudinal sectional view illustrating the ball lock mechanism, which illustrates a state where the lock balls are moved outside open holes.

FIG. 9 is a longitudinal sectional view illustrating the ball lock mechanism, which illustrates a secured state where the plug is secured in the socket.

FIG. 10 is a partial enlarged view of the part A of the ball lock mechanism illustrated in FIG. 9.

FIG. 11 is a diagram of the ball lock mechanism illustrated in FIG. 6 when viewed along the axis.

FIG. 12 is a partial enlarged view of the part B in FIG. 11

FIG. 13 is a partial longitudinal sectional view illustrating a moving mechanism of the socket.

FIG. 14 is a block diagram illustrating a control configuration of the fluid transferring connector.

FIG. 15 is a flowchart illustrating operation to connect and disconnect the plug to and from the socket.

### DETAILED DESCRIPTION

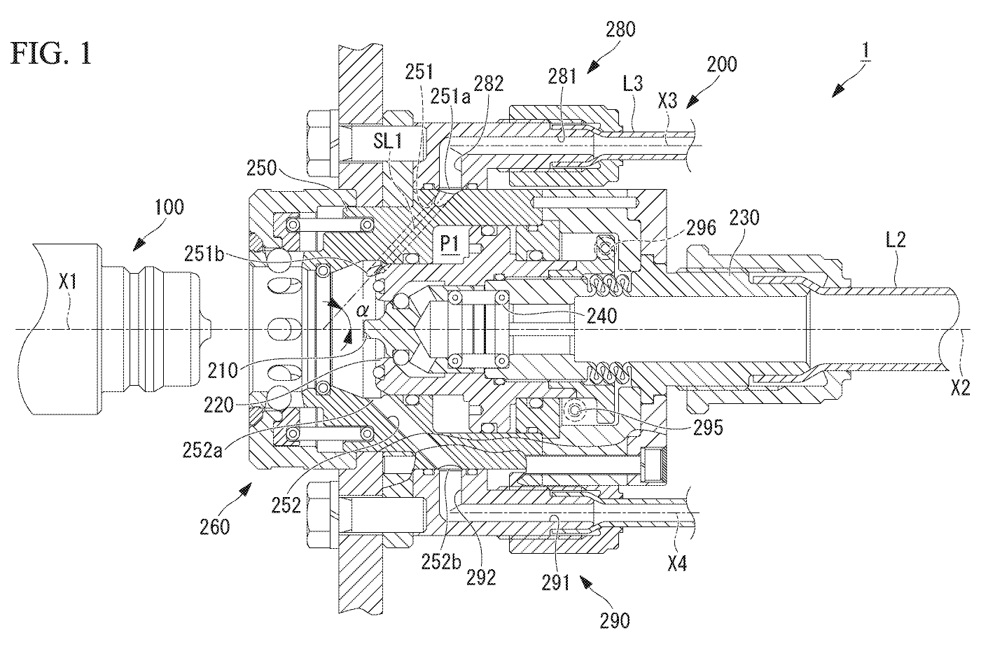

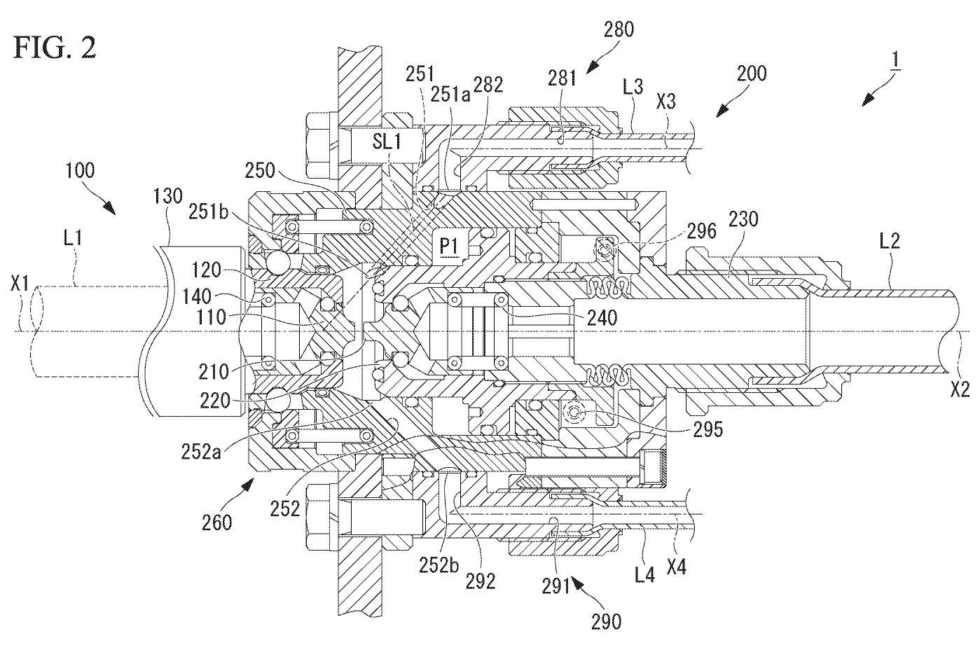

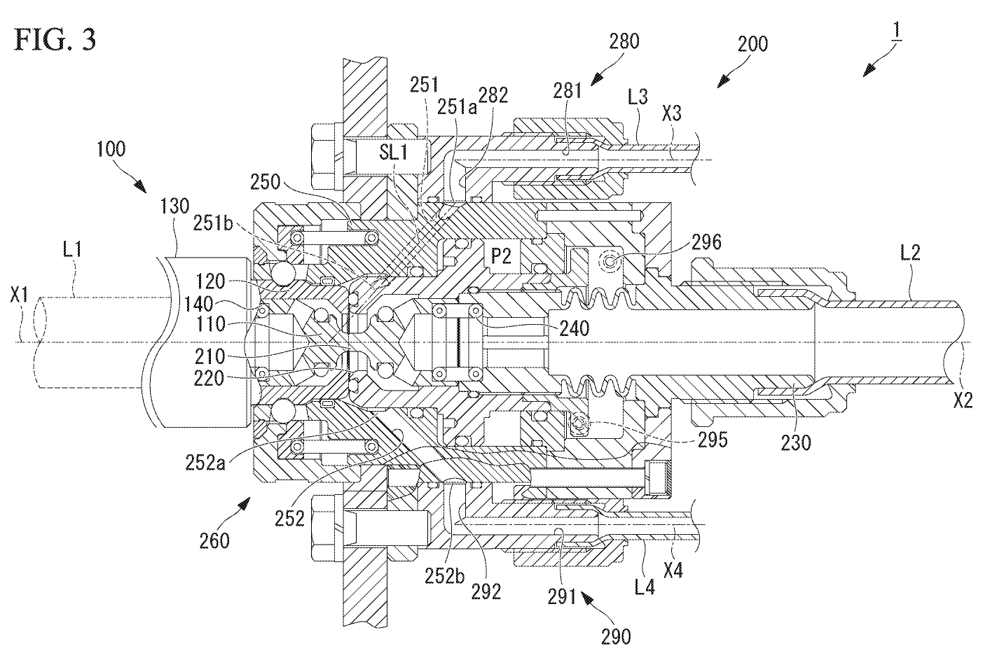

One embodiment of a fluid transferring connector 1 according to the present disclosure will be described below with reference to the drawings. FIG. 1 to FIG. 3 are longitudinal sectional views illustrating the fluid transferring connector 1 according to one embodiment of the present disclosure. FIG. 1 illustrates an uncoupled state where a plug 100 is disconnected from a socket 200. FIG. 2 illustrates a coupled state where the plug 100 is coupled to the socket 200 and a blocked state where a first pipe L1 and a second pipe L2 are not in communication with each other. FIG. 3 illustrates a coupled state where the plug 100 is coupled to the socket 200 and a flow-through state where the first pipe L1 and the second pipe L2 are in communication with each other.

As illustrated in FIG. 1 to FIG. 3, the fluid transferring connector 1 according to one embodiment of the present disclosure includes, for example, the plug 100 attached to the end of the pipe (first pipe) L1 that allows a fluid to flow therethrough and the socket 200 into which the plug 100 is inserted and which is connected to the end of the pipe (second pipe) L2 that allows a fluid flowing in from the first pipe L1 to flow out.

When the plug 100 and the socket 200 are coupled to each other, and once the blocked state illustrated in FIG. 2 is switched to the flow-through state illustrated in FIG. 3, a fluid is ready to flow through the fluid transferring connector 1. The fluid in the present embodiment is, for example, a liquid such as pure water or a chemical liquid used in semiconductor manufacturing devices. For example, the second pipe L2 connected to a buffer tank installed in a building is connected to the socket 200. The plug 100 is attached to the end of the first pipe L1 such as a hose guided from a tank truck, for example. Note that a form in which the plug 100 is connected to the second pipe L2 and the socket 200 is connected to the first pipe L1 may be employed.

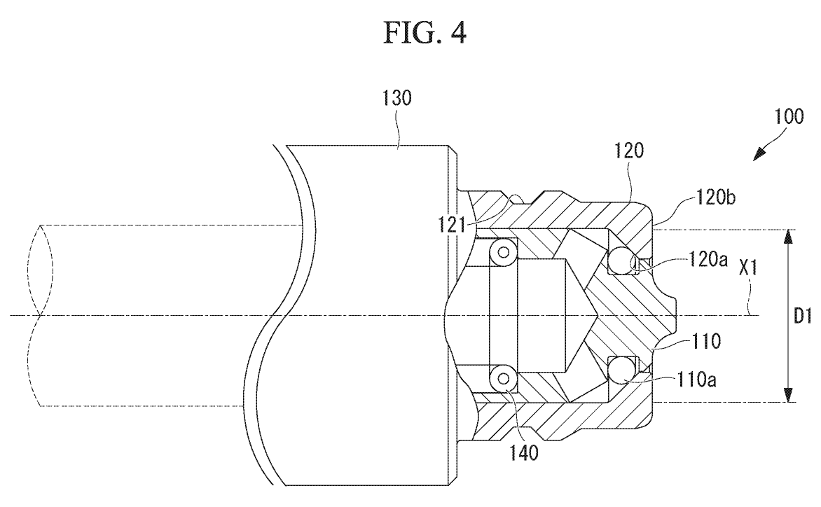

FIG. 4 is a partial enlarged view of the plug 100 illustrated in FIG. 2. As illustrated in FIG. 2 to FIG. 4, the plug 100 has a first valve part 110, a first accommodation part 120, a first main body 130, and a first spring (first biasing force generation part) 140. The first accommodation part 120 is a member that accommodates the first valve part 110 movably along an axis X1 (first axis) and is formed cylindrically.

The first main body 130 guides a fluid flowing in from the first pipe L1 to the first accommodation part 120 in which the first valve part 110 is accommodated. One end of the first spring 140 is attached to the end on the first accommodation part 120 side of the first main body 130. The other end of the first spring 140 is attached to the first valve part 110.

As illustrated in FIG. 4, the first valve part 110 is pushed against an open hole 120a of the first accommodation part 120 by the biasing force generated by the first spring 140. An O-ring 110a of the first valve part 110 pushed against the open hole 120a closes the open hole 120a into a closed state where no fluid flows through the open hole 120a. The O-ring 110a is a seal member formed of an elastic member such as rubber annularly about the axis X1.

When a second valve part 210 of the socket 200 is not in contact with the first valve part 110, the first spring 140 causes the first valve part 110 to come into contact with the first accommodation part 120 into a first closed state where no fluid of the first pipe L1 flows out of the first accommodation part 120. Further, when the second valve part 210 of the socket 200 is in contact with the first valve part 110, the first spring 140 causes the first valve part 110 and the first accommodation part 120 to be spaced apart from each other into a first open state where the fluid of the first pipe L1 flows in. The first spring 140 is a member that enables switching between the first closed state and the first open state.

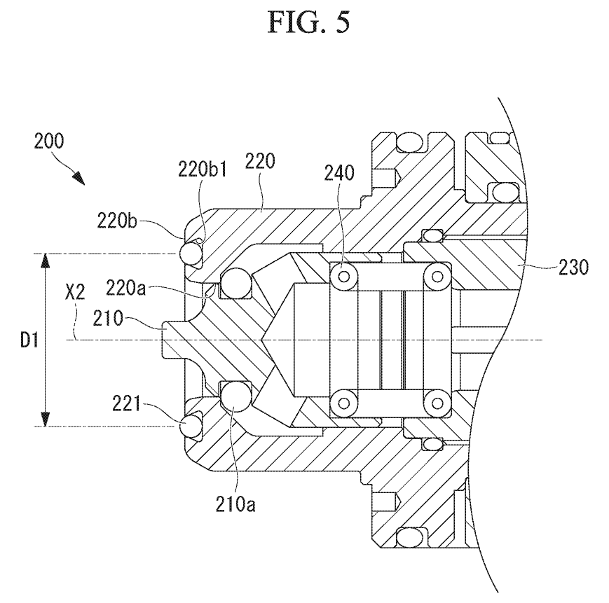

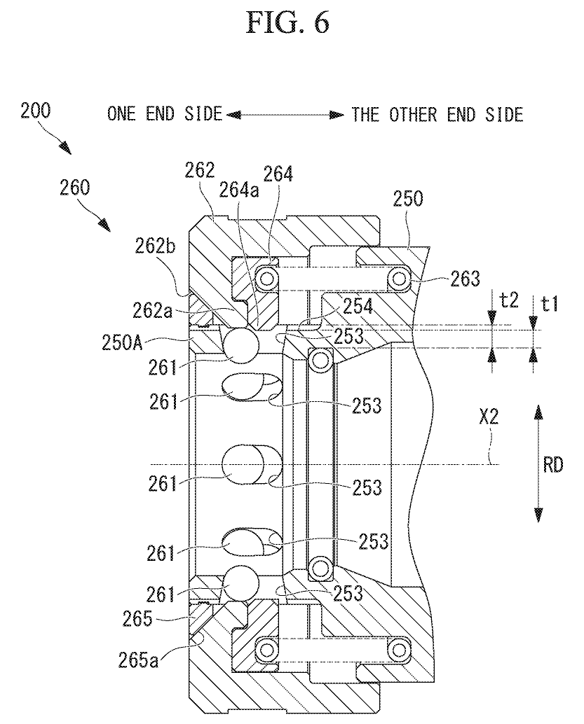

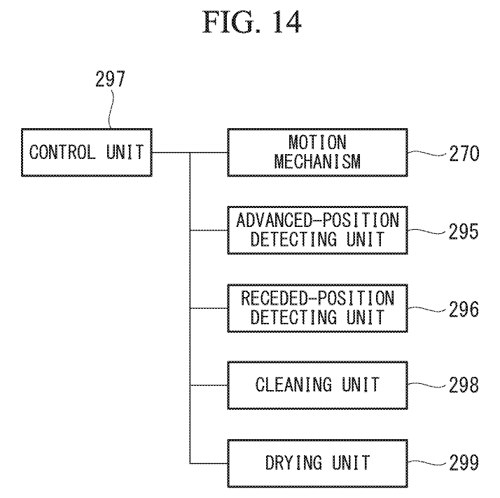

FIG. 5 is a partial enlarged view of the socket 200 illustrated in FIG. 2. FIG. 6 is a partial longitudinal sectional view illustrating a moving mechanism of the socket 200. As illustrated in FIG. 1, FIG. 2, FIG. 5, and FIG. 6, the socket 200 has the second valve part 210, a second accommodation part 220, a second main body 230, and a second spring (second biasing force generation part) 240, a housing part 250, a ball lock mechanism (fixing mechanism) 260, a moving mechanism 270, a first joint part 280, a second joint part 290, an advanced-position detecting unit 295, a receded-position detecting unit 296, and a control unit 297 (see FIG. 14).

The second accommodation part 220 is a member that accommodates the second valve part 210 movably along an axis X2 (second axis) and is formed cylindrically. As illustrated in FIG. 5, the second main body 230 is inserted in the inner circumferential side of the second accommodation part 220. One end of the second spring 240 is attached to the second main body 230. The other end of the second spring 240 is attached to the second valve part 210.

As illustrated in FIG. 5, the second valve part 210 is pushed against the open hole 220a of the second accommodation part 220 by the biasing force generated by the second spring 240. An O-ring 210a of the second valve part 210 pushed against the open hole 220a closes the open hole 220a into a closed state where no fluid flows through the open hole 220a. The O-ring 210a is a seal member formed of an elastic member such as rubber annularly about the axis X2.

When the first valve part 110 of the plug 100 is not in contact with the second valve part 210, the second spring 240 causes the second valve part 210 to come into contact with the second accommodation part 220 into a second closed state where no fluid flows into the second accommodation part 220. Further, when the first valve part 110 of the plug 100 is in contact with the second valve part 210, the second spring 240 causes the second valve part 210 and the second accommodation part 220 to be spaced apart from each other into a second open state where the fluid flows into the second pipe L2. The second spring 240 is a member that enables switching between the second closed state and the second open state.

Herein, a configuration to form a seal region for sealing the first accommodation part 120 and the second accommodation part 220 so that no fluid leaks outside the first accommodation part 120 and the second accommodation part 220 in the flow-through state illustrated in FIG. 3 will be described.

As illustrated in FIG. 4, the first accommodation part 120 has a first front end face 120b arranged facing the second accommodation part 220 of the socket 200 and formed annularly about the axis X1 so as to surround the first valve part 110. As illustrated in FIG. 5, the second accommodation part 220 has a second front end face 220b arranged facing the first accommodation part 120 and formed annularly about the axis X2 so as to surround the second valve part 210.

As illustrated in FIG. 5, an annular groove 220b1 extending about the axis X2 is formed in the second front end face 220b. An O-ring 221 is attached to the annular groove 220b1. The O-ring 221 is a seal member formed of an elastic member such as rubber annularly about the axis X2. In the flow-through state illustrated in FIG. 3, the O-ring 221 is in contact with the first front end face 120b of the first accommodation part 120, and thereby an endless seal region extending about the axis X1 is formed.

This seal region seals the first accommodation part 120 and the second accommodation part 220 so that no fluid leaks outside the first accommodation part 120 and the second accommodation part 220 in the flow-through state. As illustrated in FIG. 5, in the socket 200, a position of the diameter D1 centered on the axis X2 where the O-ring 221 is arranged serves as the seal region, and a fluid is adhered to an adhesion region surrounded by the seal region. As illustrated in FIG. 4, in the plug 100, the position of the diameter D1 centered on the axis X1 serves as the seal region, and the fluid is adhered to the adhesion region surrounded by the seal region.

The housing part 250 is a cylindrical member having one end and the other end along the axis X2, in which the first accommodation part 120 is inserted therein on the one end side and the second accommodation part 220 is inserted therein on the other end side. The housing part 250 accommodates the second accommodation part 220 moved in a direction along the axis X2 by the moving mechanism 270. The housing part 250 has a first through hole 251 and a second through hole 252.

The first through hole 251 is a hole through which the cleaning liquid is allowed to flow from a first inflow port 251a formed in the outer circumferential face of the housing part 250 to a first outflow port 251b formed in the inner circumferential face of the housing part 250. The second through hole 252 is a hole through which the cleaning liquid is discharged from a second inflow port 252a formed in the inner circumferential face of the housing part 250 to a second outflow port 252b formed in the outer circumferential face of the housing part 250. The first outflow port 251b is arranged at a position where the entire region thereof faces the outer circumferential face of the second accommodation part 220 in the flow-through state illustrated in FIG. 3 and also arranged at a position where a partial region thereof does not face the outer circumferential face of the second accommodation part 220 in the blocked state illustrated in FIG. 2.

The first through hole 251 is formed such that the adhesion region of the plug 100 is arranged on the straight line SL1 passing through the center of the first inflow port 251a and the center of the first outflow port 251b in the blocked state illustrated in FIG. 2. As illustrated in FIG. 1, the angle α of the straight line SL1 relative to the axis X2 is set within a range of 30 degrees or greater and 80 degrees or less.

The ball lock mechanism 260 is a mechanism that fixes the first accommodation part 120 of the plug 100 so as not to move along the axis X2 with respect to the housing part 250. The configuration and operation of the ball lock mechanism 260 will be described with reference to FIG. 6 to FIG. 10. FIG. 6 to FIG. 9 are longitudinal sectional views illustrating the ball lock mechanism 260.

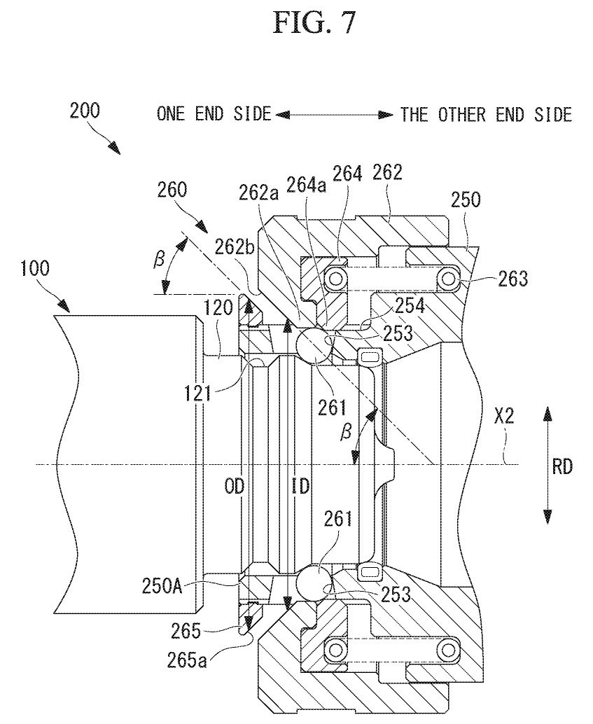

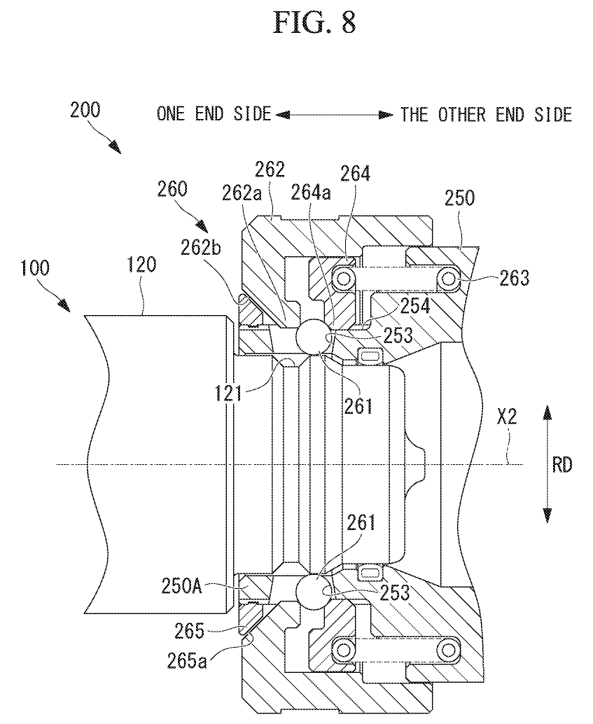

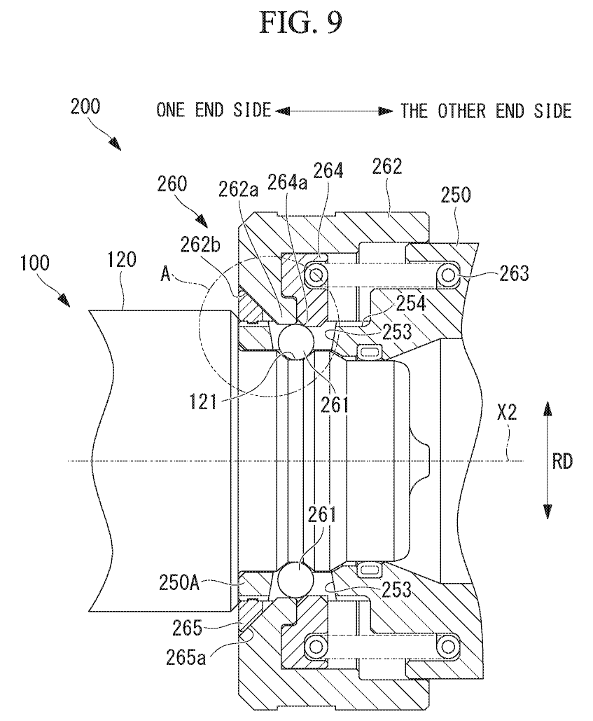

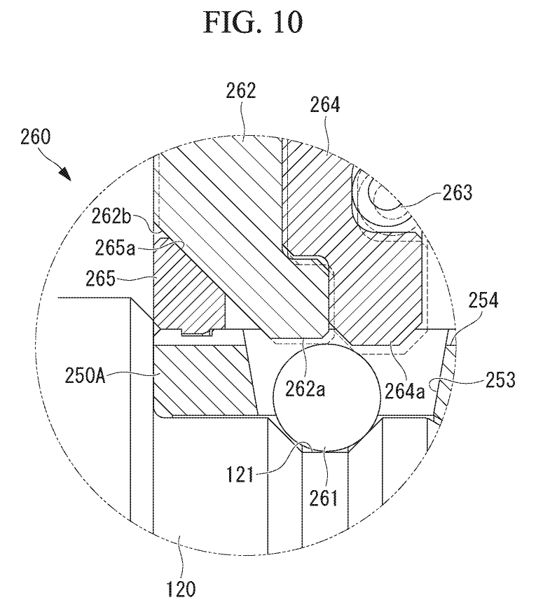

FIG. 6 illustrates an unsecured state where the plug 100 is disconnected from the socket 200. FIG. 7 illustrates a state where the plug 100 is pushed against lock balls 261. FIG. 8 illustrates a state where the lock balls 261 are moved outside of open holes 253. FIG. 9 illustrates a secured state where the plug 100 is secured in the socket 200. FIG. 10 is a partial enlarged view of the part A of the ball lock mechanism illustrated in FIG. 9.

As illustrated in FIG. 6 to FIG. 9, the ball lock mechanism 260 has a plurality of lock balls 261, a sleeve 262, a spring (biasing force generation part) 263, a spring receptacle member (transfer part) 264, and a stop ring (abutment part) 265.

A tip part 250A of the housing part 250 is formed cylindrically about the axis X2 and has a plurality of open holes 253 each having a tapered shape with a smaller diameter than the outer diameter of each spherical lock ball 261. As illustrated in FIG. 6 to FIG. 9, the plurality of lock balls 261 are accommodated in the open holes 253. Since the outer diameter of each lock ball 261 is larger than the diameter of each open hole 253, the lock ball 261 does not completely fall out of the open hole 253 on the inner circumferential side of the housing part 250.

The housing part 250 has grooves 254 formed at positions where the open holes 253 in the outer circumferential face of the tip part 250A are arranged and extending toward the other end side along the axis X2 from the open holes 253. The grooves 254 accommodate corresponding protruding parts 264a of the spring receptacle member 264 when the spring 263 contracts along the axis X2. While the thickness in the radial direction RD orthogonal to the axis X2 of the housing part 250 is smallest t1 at the positions where the grooves 254 are formed, the thickness of other positions in the circumferential direction about the axis X2 where the grooves 254 are not formed is t2 that is larger than t1.

Since the protruding parts 264a are accommodated in the grooves 254 when the spring 263 contracts along the axis X2, a state where a position in the circumferential direction about the axis X2 of the spring receptacle member 264 matches a position in the circumferential direction about the axis X2 of the housing part 250 is maintained while such contraction or accommodation is performed. Thus, the operation to cause the spring 263 to contract along the axis X2 can be reliably performed.

The sleeve 262 is a member formed circularly cylindrically about the axis X2 and arranged on the outer circumferential side of the housing part 250. The sleeve 262 is restricted by the stop ring 265 from moving to one end side (the left side in FIG. 6 to FIG. 9) along the axis X2 and restricted by the housing part 250 from moving to the other end side (the right side in FIG. 6 to FIG. 9) along the axis X2.

The sleeve 262 is movable along the axis X2 within the range restricted by the housing part 250 and the stop ring 265. The sleeve 262 has a restriction part 262a that restricts the plurality of lock balls 261, which are accommodated in the open holes 253, to remain in a state of being engaged with an engagement groove 121 of the first accommodation part 120 of the plug 100. The sleeve 262 has a first slope face 262b arranged facing the stop ring 265 along the axis X2 and having a gradually expanding inner diameter ID at a constant gradient of an angle γ toward the one end side along the axis X2. The first slope face 262b is formed circumferentially about the axis X2 continuously over the entire circumference.

The spring 263 is an elastic member, one end side thereof along the axis X2 is fixed to the housing part 250, and the other end side thereof along the axis X2 is fixed to the sleeve 262 via the spring receptacle member 264. The spring 263 generates a biasing force caused by elastic deformation and pushes the sleeve 262 so that the restriction part 262a of the sleeve 262 is in contact with the lock ball 261.

The spring receptacle member 264 is a member that supports one end side in the axis X2 of the spring 263 and transfers the biasing force generated by the spring 263 to the sleeve 262. The spring receptacle member 264 has the protruding parts 264a formed in a plurality of portions circumferentially about the axis X2 and accommodated in the groove 254 when the spring 263 contracts along the axis X2. As illustrated in FIG. 10, the protruding parts 264a more protrude to the lock balls 261 side than the restriction parts 262a.

The stop ring 265 is a member which is attached to the outer circumferential face of the tip part 250A of the housing part 250 and formed annularly about the axis X2 and against which the sleeve 262 pushed by the spring 263 is abutted. As illustrated in FIG. 7, the stop ring 265 has a second slope face 265a arranged facing the first slope face 262b along the axis X2 and having a gradually expanding outer diameter OD at a constant gradient of a predetermined angle β toward the one end side along the axis X2. The second slope face 265a is formed circumferentially about the axis X2 continuously over the entire circumference. As illustrated in FIG. 6 and FIG. 9, the first slope face 262b is abutted against the second slope face 265a due to the biasing force generated by the spring 263.

When the central axis of the sleeve 262 does not match the central axis of the stop ring 265, the first slope face 262b is moved while being in contact with the second slope face 265a by the biasing force transferred from the spring 263 to the sleeve 262 so that the central axis of the sleeve 262 matches the central axis of the stop ring 265. As illustrated in FIG. 10, the sleeve 262 and the spring receptacle member 264 arranged at the positions indicated by dotted lines are moved to the positions indicated by solid lines.

Herein, the operation to fix the plug 100 to the housing part 250 of the socket 200 by using the ball lock mechanism 260 will be described. The ball lock mechanism 260 of the present embodiment is a mechanism with which the operator performs operation to hold and insert the plug 100 into the socket 200 without touching the sleeve 262 and thereby is able to obtain a state where the plug 100 is secured in the socket 200.

In the unsecured state illustrated in FIG. 6, the operator grips and inserts the plug 100 into the housing part 250 along the axis X2 to obtain a state where the outer circumferential face of the plug 100 is in contact with the lock balls 261. Once the operator pushes the plug 100 into the other end side with the outer circumferential face of the plug 100 being in contact with the lock balls, the lock balls 261 are moved toward the other end side along the axis X2, and the state illustrated in FIG. 7 is obtained. FIG. 7 illustrates a state resulted after the lock balls 261 have come into contact with the protruding parts 264a protruding on the lock ball 261 side from the restriction part 262a and have been moved along the axis X2 to the position restricted by the open holes 253.

Once the operator applies a force to further insert the plug 100 into the socket 200 from the state illustrated in FIG. 7, the lock balls 261 are moved toward outside in the radial direction RD orthogonal to the axis X2 from the open holes 253, and the state illustrated in FIG. 8 is obtained. The operator then applies a force to further insert the plug 100 into the socket 200, and this results in a state where the lock balls 261 are engaged with the engagement groove 121 formed in the outer circumferential face of the first accommodation part 120 of the plug 100.

Once the state where the lock balls 261 have been engaged with the engagement groove 121 is obtained, the biasing force generated by the spring 263 is transferred to the sleeve 262 via the spring receptacle member 264, and this results in the state illustrated in FIG. 9 where the sleeve 262 is abutted against the stop ring 265. In this state, the restriction part 262a of the sleeve 262 comes into contact with the lock balls 261, and the lock balls 261 are restricted to a state of being engaged with the engagement groove 121. In such a way, by performing the operation to hold and insert the plug 100 into the socket 200 without touching the sleeve 262, the operator is able to obtain a state where the plug 100 is secured in the socket 200.

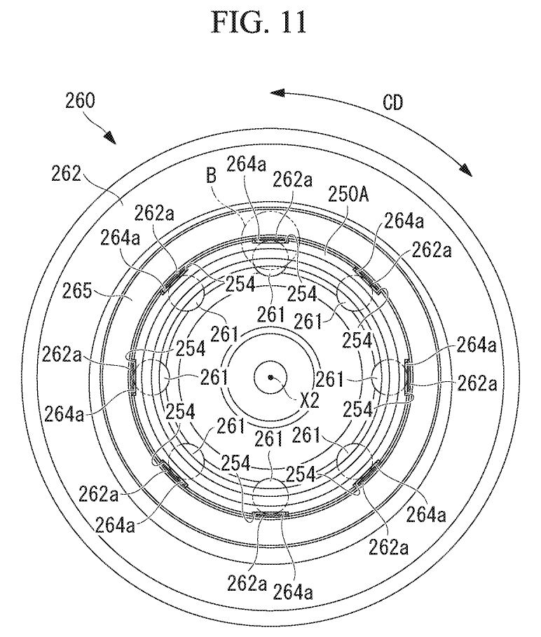

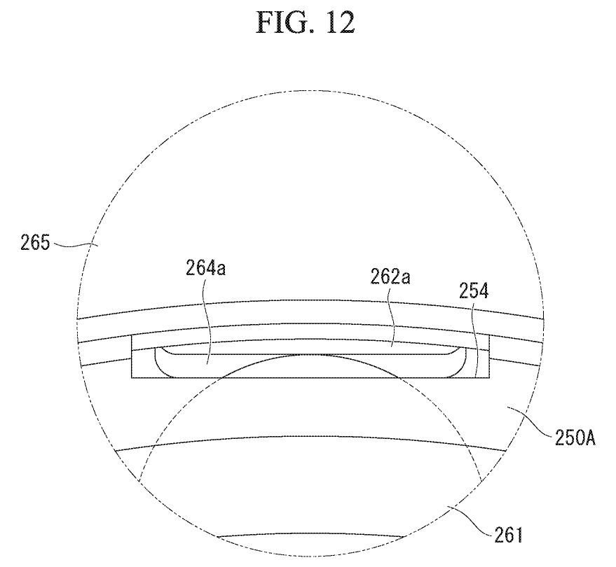

FIG. 11 is a diagram of the ball lock mechanism 260 illustrated in FIG. 6 when viewed along the axis X2. FIG. 12 is a partial enlarged view of the part B in FIG. 11. As illustrated in FIG. 11 and FIG. 12, the grooves 254 of the housing part 250 are formed at multiple portions (in the example illustrated in FIG. 11, eight portions at 45-degree intervals) along the circumferential direction CD about the axis X2. In the sleeve 262, the restriction parts 262a protruding inward in the radial direction RD are formed at multiple portions (in the example illustrated in FIG. 11, eight portions at 45-degree intervals) along the circumferential direction CD. In the spring receptacle member 264, the protruding parts 264a protruding inward in the radial direction RD are formed at multiple portions (in the example illustrated in FIG. 11, eight portions at 45-degree intervals) along the circumferential direction CD.

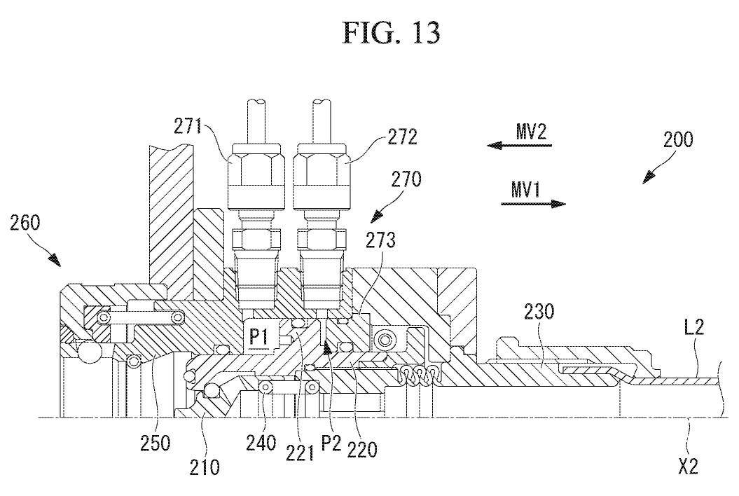

FIG. 13 is a partial longitudinal sectional view illustrating the moving mechanism 270 of the socket 200. The moving mechanism 270 is a mechanism that moves the second accommodation part 220 in a direction toward or away from the first accommodation part 120 along the axis X2 with respect to the housing part 250 and thereby performs switching between the flow-through state where the first valve part 110 and the second valve part 210 are in contact with each other and the blocked state where the first valve part 110 and the second valve part 210 are not in contact with each other. The moving mechanism 270 has a first intake/exhaust port 271, a second intake/exhaust port 272, and an annular member 273. The annular member 273 is a member formed annularly about the axis X2 and is arranged between the outer circumferential face of the second accommodation part 220 and the inner circumferential face of the housing part 250.

The moving mechanism 270 supplies compressed air (compressed gas) from the first intake/exhaust port 271 to a first pressure chamber P1 to increase the pressure of the first pressure chamber P1 to be higher than the pressure of a second pressure chamber P2 and moves the second accommodation part 220 along a first moving direction MV1 (the direction from the left to the right in FIG. 13), and this results in the blocked state illustrated in FIG. 2. Further, the moving mechanism 270 supplies compressed air (compressed gas) from the second intake/exhaust port 272 to a second pressure chamber P2 to increase the pressure of the second pressure chamber P2 to be higher than the pressure of the first pressure chamber P1 and moves the second accommodation part 220 along a second moving direction MV2 (the direction from the right to the left in FIG. 13), and this results in the flow-through state illustrated in FIG. 3.

The first joint part 280 has an inflow channel 281 extending along an axis X3 parallel to the axis X2 and a first coupling channel 282 coupling the inflow channel 281 to the first inflow port 251a. A third pipe L3 that supplies a cleaning liquid from a cleaning liquid tank (not illustrated) is connected to the inflow channel 281. The cleaning liquid supplied from the third pipe L3 to the first joint part 280 is supplied to the first inflow port 251a via the inflow channel 281 and the first coupling channel 282.

The second joint part 290 has a discharge channel 291 extending along an axis X4 parallel to the axis X2 and a second coupling channel 292 coupling the second outflow port 252b and the discharge channel 291 to each other. A fourth pipe L4 that supplies the cleaning liquid to a waste liquid tank (not illustrated) is connected to the discharge channel 291. The cleaning liquid discharged from the second outflow port 252b to the second joint part 290 is supplied to the fourth pipe L4 via the second coupling channel 292 and the discharge channel 291.

The advanced-position detecting unit 295 is a sensor configured to detect whether or not the second accommodation part 220 moved by the moving mechanism 270 is arranged at an advanced position in the flow-through state illustrated in FIG. 3. The advanced-position detecting unit 295 detects that the second accommodation part 220 is arranged at the advanced position when the front of the advanced-position detection unit 295 is blocked by the second accommodation part 220 moved along the axis X2.

The receded-position detecting unit 296 is a sensor configured to detect whether or not the second accommodation part 220 moved by the moving mechanism 270 is arranged at a receded position in the blocked state illustrated in FIG. 2. The receded-position detecting unit 296 detects that the second accommodation part 220 is arranged at the receded position when the front of the advanced-position detection uni 295 is blocked by the second accommodation part 220 moved along the axis X2.

As illustrated in FIG. 1 to FIG. 3, the advanced-position detecting unit 295 and the receded-position detecting unit 296 are arranged at circumferentially different positions about the axis X2. With such arrangement, interference between the advanced-position detecting unit 295 and the receded-position detecting unit 296 can be prevented compared to a case where these units are arranged at the same circumferential position.

The control unit 297 is a device configured to control each unit of the fluid transferring connector 1 including the moving mechanism 270, the advanced-position detecting unit 295, and the receded-position detecting unit 296. FIG. 14 is a block diagram illustrating the control configuration of the fluid transferring connector 1. As illustrated in FIG. 14, the control unit 297 controls the supply state of a cleaning unit 298 configured to supply a cleaning liquid to the first joint part 280 and the supply state of a drying unit 299 configured to supply a drying gas (for example, a nitrogen gas) to the first joint part 280.

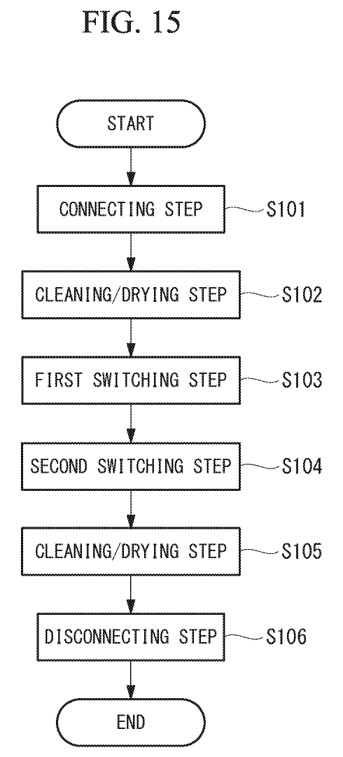

Next, the operation to connect and disconnect the plug 100 to and from the socket 200 will be described. FIG. 15 is a flowchart illustrating the operation to connect and disconnect the plug to and from the socket.

In step S101, the operator inserts the plug 100 into the socket 200 and secures the plug 100 in the socket 200 by using the ball lock mechanism 260. Accordingly, the plug 100 is connected to the socket 200 into the state illustrated in FIG. 2.

In step S102, in response to an instruction from the operator, the control unit 297 controls the cleaning unit 298 to supply a cleaning liquid from the cleaning unit 298 to the first joint part 280 for a predetermined time. The cleaning liquid supplied to the first joint part 280 cleans the first valve part 110, the first accommodation part 120, the second valve part 210, and the second accommodation part 220 and is discharged from the second joint part 290.

Next, in response to an instruction from the operator, the control unit 297 controls the drying unit 299 to supply a drying gas from the drying unit 299 to the first joint part 280 for a predetermined time. The drying gas supplied to the first joint part 280 dries the first valve part 110, the first accommodation part 120, the second valve part 210, and the second accommodation part 220 and is discharged from the second joint part 290.

In step S103, the control unit 297 moves the second accommodation part 220 from the receded position to the advanced position by the moving mechanism 270 so as to transfer the blocked state illustrated in FIG. 2 to the flow-through state illustrated in FIG. 3. In response to transition from the state where the receded-position detecting unit 296 detects the second accommodation part 220 to the state where the advanced-position detecting unit 295 detects the second accommodation part 220, the control unit 297 determines that the first switching step of switching the blocked state into the flow-through state has been completed.

A state where the fluid is transferred from the first pipe L1 to the second pipe L2 is obtained by step S101 to step S103 described above. When switching the state where the fluid is transferred from the first pipe L1 to the second pipe L2 into a state where no fluid is transferred from the first pipe L1 to the second pipe L2, the operator allows the subsequent step S104 to step S106 to be performed.

In step S104, the control unit 297 moves the second accommodation part 220 from the advanced position to the receded position by the moving mechanism 270 so as to transfer the flow-through state illustrated in FIG. 3 to the blocked state illustrated in FIG. 2. In response to transition from the state where the advanced-position detecting unit 295 detects the second accommodation part 220 to the state where the receded-position detecting unit 296 detects the second accommodation part 220, the control unit 297 determines that the second switching step of switching the flow-through state into the blocked state has been completed.

In step S105, in response to an instruction from the operator, the control unit 297 controls the cleaning unit 298 to supply a cleaning liquid from the cleaning unit 298 to the first joint part 280 for a predetermined time. The cleaning liquid supplied to the first joint part 280 cleans the first valve part 110, the first accommodation part 120, the second valve part 210, and the second accommodation part 220 and is discharged from the second joint part 290.

Next, in response to an instruction from the operator, the control unit 297 controls the drying unit 299 to supply a drying gas from the drying unit 299 to the first joint part 280 for a predetermined time. The drying gas supplied to the first joint part 280 dries the first valve part 110, the first accommodation part 120, the second valve part 210, and the second accommodation part 220 and is discharged from the second joint part 290.

In step S106, the operator releases the state where the plug 100 is secured in the socket 200 by using the ball lock mechanism 260 and disconnects the plug 100 from the socket 200. Accordingly, the plug 100 is disconnected from the socket 200 into the state illustrated in FIG. 1.

The effects and advantages achieved by the fluid transferring connector 1 of the present embodiment described above will be described.

According to the fluid transferring connector 1 of the present embodiment, the operator inserts the plug 100 into the socket 200 and operates a ball lock mechanism 260 of the socket 200, and thereby the plug 100 is fixed so as not to move along the axis X2 with respect to the housing part 250 of the socket 200. Once the second accommodation part 220 is moved along the axis X2 to switch the blocked state to the flow-through state with the plug 100 being fixed to the housing part 250, the first valve part 110 of the plug 100 and the second valve part 210 of the socket 200 come into contact with each other. This results in a state where a fluid flows through from the first pipe L1 on the plug 100 side to the second pipe L2 on the socket 200 side.

According to the fluid transferring connector 1 of the present embodiment, when the plug 100 is inserted in the socket 200, once the sleeve 262 pushed by the spring 263 is abutted against the stop ring 265 with the lock balls 261 being engaged with the engagement groove 121, the restriction parts 262a of the sleeve 262 come into contact with the lock balls 261, and the lock balls 261 are restricted into a state of being engaged with the engagement groove 121. When the sleeve 262 is abutted against the stop ring 265, the first slope face 262b of the sleeve 262 and the second slope face 265a of the stop ring 265 come into contact with each other.

When the central axis of the sleeve 262 does not match the central axis of the stop ring 265, the first slope face 262b is moved while being in contact with the second slope face 265a by the biasing force transferred from the spring 263 to the sleeve 262 so that the central axis of the sleeve 262 matches the central axis of the spring 263. Accordingly, even when the first slope face 262b comes into contact with the second slope face 265a in a state where the central axis of the sleeve 262 does not match the central axis of the stop ring 265, the sleeve 262 is moved so that the central axis of the sleeve 262 matches the central axis of the stop ring 265. In such a way, according to the fluid transferring connector 1 of the present embodiment, since a state where the central axis of the sleeve 262 matches the central axis of the stop ring 265 is obtained, a state where the lock balls 261 are reliably secured in the engagement groove 121 can be obtained when the plug 100 is secured in the socket 200 by the ball lock mechanism 260.

According to the fluid transferring connector 1 of the present embodiment, once the operator inserts the plug 100 into the socket 200, the outer circumferential face of the plug 100 comes into contact with the lock balls 261, and the lock balls 261 are moved toward the other end side along the axis X2. When the lock balls 261 are moved, the lock balls 261 come into contact with the protruding parts 264a that more protrude to the lock balls 261 side than the restriction parts 262a, and the lock balls 261 are moved along the axis X2 to the position where the lock balls 261 are restricted by the open holes 253. Once the operator applies a force to further insert the plug 100 into the socket 200, the lock balls 261 are moved outward in the radial direction RD from the open holes 253, and a state where the lock balls 261 are engaged with the engagement groove 121 formed in the outer circumferential face of the first accommodation part 120 of the plug 100 is then obtained.

Once a state where the lock balls 261 are engaged with the engagement groove 121 is obtained, a biasing force generated by the spring 263 is transferred to the sleeve 262 via the spring receptacle member 264 into a state where the sleeve 262 is abutted against the stop ring 265. In this state, the restriction parts 262a of the sleeve 262 come into contact with the lock balls 261, and the lock balls 261 are restricted into a state of being engaged with the engagement groove 121. In such a way, by performing operation to hold and insert the plug 100 into the socket 200 without touching the sleeve 262, the operator is able to obtain a state where the plug 100 is secured in the socket 200.

According to the fluid transferring connector 1 of the present embodiment, the grooves 254 that accommodate the protruding parts 264a when the protruding parts 264a are moved along the axis X2 are formed only at positions where the open holes 253 are arranged in the housing part 250. Thus, while the thickness of the tip part 250A of the housing part 250 in the region in which each groove 254 is formed is smaller by the size of the groove 254, the thickness of the tip part 250A is larger in the region in which the groove 254 is not formed than in the region in which the groove 254 is formed. With such a sizing, the strength of the housing part 250 is sufficiently ensured, and a state where the plug 100 is secured in the socket 200 by the ball lock mechanism 260 can be reliably maintained even when a load due to the weight of the first pipe L1 and a fluid flowing through the first pipe L1 acts on the plug 100.

According to the fluid transferring connector 1 of the present embodiment, even when the central axis of the sleeve 262 is shifted at any position in the circumferential direction CD with respect to the central axis of the stop ring 265, the first slope face 262b can be moved while being in contact with the second slope face 265a so that the central axis of the sleeve 262 matches the central axis of the stop ring 265.

According to the fluid transferring connector 1 of the present embodiment, by moving the second accommodation part 220 along the axis X2 by using the moving mechanism 270 with the plug 100 being fixed to the housing part 250 by the ball lock mechanism 260, it is possible to switch the blocked state to the flow-through state while allowing the first valve part 110 of the plug 100 and the second valve part 210 of the socket 200 to be in contact with each other. Further, by moving the second accommodation part 220 along the axis X2 by using the moving mechanism 270, it is possible to switch the flow-through state to the blocked state while allowing the first valve part 110 of the plug 100 and the second valve part 210 of the socket 200 to be spaced apart from each other.

What is claimed is:

1. A fluid transferring connector comprising:
a plug configured to be attached to an end of a first pipe, a fluid being allowed to flow through the first pipe; and
a socket configured to be connected to a second pipe, the plug being inserted in the socket, a fluid flowing in from the first pipe being allowed to flow out of the second pipe,
wherein the plug includes
a first valve part,
a cylindrical first accommodation part that accommodates the first valve part movably along a first axis, and
a first biasing force generation part configured to generate a biasing force so as to cause the first valve part to come into contact with the first accommodation part into a first closed state where the fluid in the first pipe does not flow out of the first accommodation part,
wherein the socket includes
a second valve part,
a cylindrical second accommodation part that accommodates the second valve part movably along a second axis,
a second biasing force generation part configured to generate a biasing force so as to cause the second valve part to come into contact with the second accommodation part into a second closed state where no fluid flows into the second accommodation part,
a cylindrical housing part having one end and the other end along the second axis, the first accommodation part being inserted in the one end side, and the second accommodation part being inserted in the other end side, and
a ball lock mechanism configured to fix the first accommodation part not to move along the second axis with respect to the housing part,
wherein the ball lock mechanism includes
a plurality of lock balls accommodated in a plurality of open holes formed at a plurality of portions in a circumferential direction about the second axis of a tip part of the housing part,
a sleeve formed in a circular cylindrical shape about the second axis and arranged on an outer circumferential side of the tip part, and the sleeve having restriction parts configured to restrict the lock balls accommodated in the open holes into a state where the lock balls are engaged with an engagement groove formed about the first axis in an outer circumferential face of the second accommodation part,
a third biasing force generation part fixed to the second accommodation part and configured to push the sleeve toward a position where the restriction parts come into contact with the lock balls, and
an abutment part attached to the tip part of the housing part and formed annularly about the second axis, the sleeve pushed by the third biasing force generation part being abutted against the abutment part,
wherein the sleeve has a first slope face arranged facing the abutment part along the second axis and having an inner diameter that gradually expands at a gradient of a predetermined angle toward one end side along the second axis,
wherein the abutment part has a second slope face arranged facing the first slope face along the second axis and having an outer diameter that gradually expands at a gradient of the predetermined angle toward one end side along the second axis, and
wherein the first slope face is abutted against the second slope face by a biasing force generated by the third biasing force generation part.

2. The fluid transferring connector according to claim 1,
wherein the ball lock mechanism has a transfer part configured to support one end side on the second axis of the third biasing force generation part and transfer a biasing force generated by the third biasing force generation part to the sleeve,
wherein the housing part has grooves formed at positions where the open holes in the outer circumferential face of the tip part are arranged and extending from the open holes toward the other end side along the second axis,
wherein the transfer part has protruding parts formed at a plurality of portions in the circumferential direction and accommodated in the grooves when the third biasing force generation part contracts along the second axis, and
wherein the protruding parts more protrude to the lock balls side than the restriction parts.

3. The fluid transferring connector according to claim 1, wherein the first slope face and the second slope face are formed continuously in the circumferential direction.

4. The fluid transferring connector according to claim 1, wherein the socket has a moving mechanism configured to move the second accommodation part in a direction toward or away from the first accommodation part along the second axis with respect to the housing part to perform switching between a flow-through state where the first valve part and the second valve part are in contact with each other and a blocked state where the first valve part and the second valve part are not in contact with each other.
